(19) United States
(12) Patent Application Publication
(10) Pub. No.: US 2009/0226574 A1
(43) Pub. Date: Sep. 10, 2009

(54) APPARATUS AND METHOD FOR A MICROWAVEABLE FROZEN BEVERAGE

(76) Inventor: Thomas R. Johnson, Fort Wayne, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/041,970

(22) Filed: Mar. 4, 2008

(51) Int. Cl. B65D 85/72; B65D 81/34; A23L 2/02; A23L 2/38; A23F 3/00

(52) U.S. Cl. 426/107; 426/590; 426/597; 426/599; 426/592; 426/115; 426/234

(57) ABSTRACT

A sealed microwaveable container including a frozen beverage comprising ice chunks enclosed in a beverage solid is provided. The beverage has a freezing point below that of water allowing for the beverage to be thawed to a substantially liquid form using a prescribed microwave process while solid ice chunks are preserved to create an iced beverage. A plurality of opening for dispensing the beverage may be provided, such as one or more of a plurality of releasable or puncturable seals.

### FIELD OF THE INVENTION

The present invention relates in general to frozen beverages. More particularly, the present invention relates to beverages stored in a frozen state suitable for preparation in a microwave oven.

### BACKGROUND OF THE INVENTION

Beverages such as tea, soda, lemonade, cocktails, and many others have been enjoyed with ice for well over a hundred years. More recently, other beverages such as coffee have become popular when served on ice. Typically, iced beverages are prepared by combining ice cubes, commonly from an ice maker, and a pre-prepared liquid of choice in a cup, glass, or other appropriate container.

Additionally, slush-like beverages have been a popular alternative to an iced beverage. Most often, the slush-like beverage is prepared by adding the necessary ingredients to water in a machine which cools the mix to an appropriate temperature while constantly mixing it in order to prevent it from freezing solid. Typically, fruit juices, flavoring, coloring, and acid solutions of fruit acids comprise the flavor and color mixture. The popularity of slush-like beverages has led to a desire to produce a beverage product suitable for re-creating the popular beverage at home. The most common solution has been a beverage sealed in a malleable container for freezing. The beverage inside the container is then removed from the freezer and heated in some fashion, such as by lying on the counter, or otherwise to attain a slush-like state. The beverage is then shaken and a somewhat satisfactory slush mixture can be achieved. However, the texture and consistency of its commercially produced counterpart is unmatched by these products, and as such, they have had limited success.

While a great bit of attention has been paid to conveniently providing slush-like beverages within the home, very little if any attention has been placed on providing convenient pre-packaged beverages with ice included. A problem with the traditional notion of keeping a beverage in liquid form in a refrigerator and combining it with ice cubes from a freezer just prior to consumption is that oftentimes beverages, in liquid form, cannot be maintained in the refrigerator for extended periods of time. Additionally, preparing a beverage, such as a cocktail, or the like often takes too much time when only a single serving is desired. These limitations, amongst many others, indicate a need for an improved pre-packaged beverage suitable for convenient storage and rapid preparation, such as in a microwave oven.

### SUMMARY OF THE INVENTION

One embodiment of the present invention is a unique frozen beverage product suitable for storage in a low temperature environment, such as a freezer, and subsequent preparation in a microwave oven. Under specified microwave oven time and power levels, a beverage having a liquid component and significant ice chunks therein is provided.

A further embodiment includes a frozen beverage product containing alcohol, such as ethanol from a spirit, which depresses the freezing point of the beverage allowing for ice chunks to be frozen therein and remain substantially intact during the thawing process carried out in a microwave oven.

An alternate embodiment includes a method for manufacturing a frozen beverage comprising a liquid having a depressed freezing point and a plurality of sizeable ice chunks. The beverage is hermetically sealed within a container and frozen solid for transportation, sale, storage, and ultimate use.

An additional embodiment includes a method for preparing a frozen beverage for consumption as a beverage including ice. The method includes a microwave step in which the entire beverage is irradiated with microwaves of a predetermined power level for a specified time in a microwave oven.

This summary is provided to introduce a selection of concepts in a simplified form that are described in further detail in the detailed description and drawings contained herein. This summary is not intended to identify key features or essential features of the claimed subject matter, nor is it intended to be used as an aid in determining the scope of the claimed subject matter. Yet other forms, embodiments, objects, advantages, benefits, features, and aspects of the present invention will become apparent from the detailed description and drawings contained herein.

### BRIEF DESCRIPTION OF THE DRAWINGS

FIG. 1A is a perspective view of one embodiment of a container suitable for use within the present invention.

FIG. 1B is an exploded perspective view of the container of FIG. 1A.

FIG. 2 is a flowchart illustrating one set of steps for manufacturing a frozen beverage product containing ice chunks according to the present invention.

FIG. 3 is a cross sectional view of the container of FIG. 1A in its frozen state, taken along the line A-A in FIG. 1A and viewed in the direction of the arrows.

FIG. 4 is a flowchart illustrating one set of steps for preparing a frozen beverage product containing ice chunks for consumption according to the present invention.

FIG. 5 is a cross sectional view of the container of FIG. 1A in its prepared state, taken along the line A-A in FIG. 1A and viewed in the direction of the arrows.

FIG. 6 is a perspective view of one embodiment of a product containing several containers suitable for use within the present invention.

### DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended. Alterations and modifications in the illustrated device, and further applications of the principles of the invention as illustrated therein are herein contemplated as would normally occur to one skilled in the art to which the invention relates.

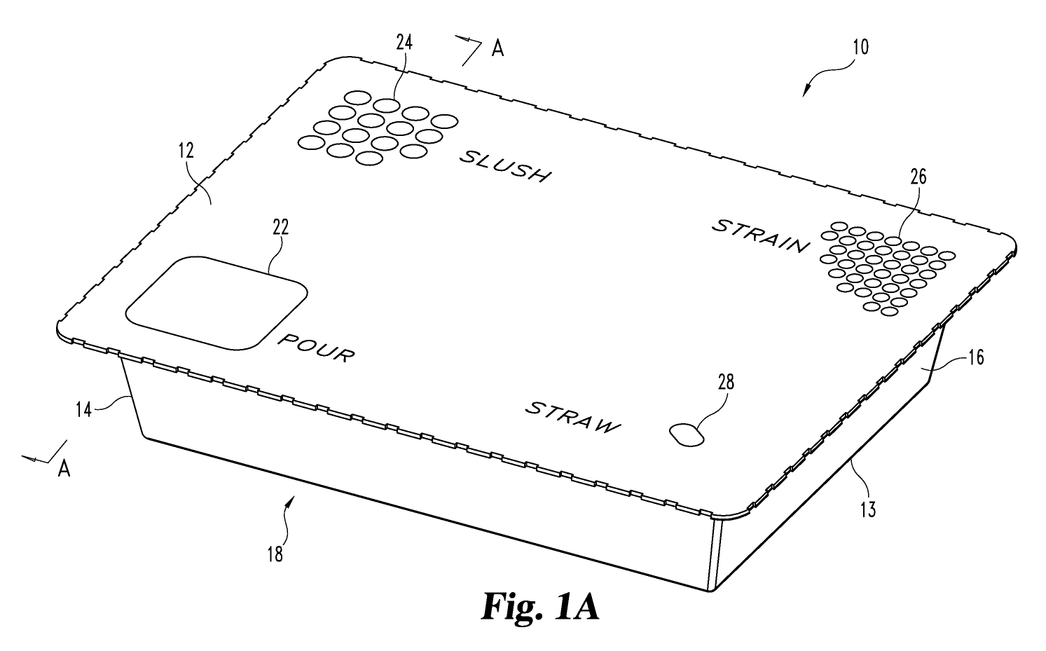

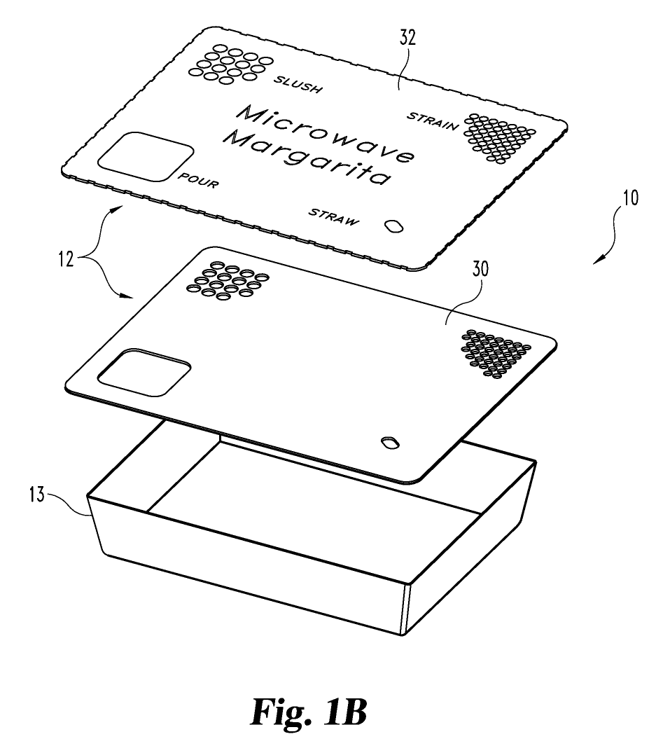

Referring to FIG. 1A, a representative embodiment of a pre-packaged frozen beverage takes the form of container 10. Container 10 may be any suitable microwaveable packaging for storing liquid including, but not limited to, a semi-rigid bottle, a pouch, a carton or any other liquid storage device known to one of skill in the art. In the illustrated embodiment, container 10 is a sealed enclosure manufactured from microwaveable compositions suitable for preserving the beverage contained therein. In this preferred embodiment, container 10 is suitable for holding a single-serving, such as 6-16 ounces of a selected beverage. In alternative embodiments, container 10 may hold larger quantities, such as 24, 32, or 64 ounces, or any other desired quantity. Larger sizes of container 10, such as 32 and 64 ounces may be desirable for use in preparing the beverage contained therein for a number of individuals, and/or for multiple servings for a single individual.

As illustrated, container 10 comprises a top 12 and bottom 13. Bottom 13 includes side face 14 and side face 16 with corresponding opposing sides, and bottom 18. Extensive experimentation has been conducted into the ideal shape of the container in order to optimize the distribution of the radiation during microwaving. This provides an even distribution of heat in order to effectively liquefy the desired portions of the solid container therein, namely the beverage, without overheating, and thus melting, the ice chunks of the solid which are desired to remain in the frozen state. Container 10 may be in a any number of various shapes, including but not limited to rectangular, circular, oblong, or elliptical. Preferably, container 10 measures at least 5″ in length by 4″ in width, while measuring at most 2.5″ in height. In a further preferred embodiment, container 10 measures about 6″ in length by about 5″ in width, while measuring about 1.5″ in height. Generally, the height of container 10 should not exceed 50% of the width or height. Preferably, the height of container 10 will not exceed 30% of the width or height in order to promote the even melting perceived during experimentation. It shall be appreciated that the length and width of container 10 are defined to be their maximum dimension in one of two perpendicular directions. When positioned within a microwave for heating, it is desired that these dimension be parallel to the bottom surface of the microwave oven and perpendicular to the height of the container.

Additionally, container 10 may have rounded internal corners having a radius of at most 1″ and preferably at most 0.5″ to promote even heating of the beverage contained therein during microwaving. Additionally, container 10 may be appropriately sized to hold a selected quantity of the selected beverage, such as 4, 6, 8, 16, 32, or 96 ounces, depending upon desired use. In the preferred embodiment, single serving beverage quantities of between 8 and 16 ounces are utilized. Of course, any other beverage quantity may be provided for.

Preferably, container 10 is hermetically sealed. A hermetical seal shall be defined for purposes of this disclosure to be an absolutely airtight container seal which prevents reentry of air or microorganisms into packaged foods products, such as those known to one of skill in the food industry. Reusable plastic containers alone, such as those market under the trademark Tupperware®, and cellophane wrapping commonly used in supermarket meat departments do not provide the requisite hermetic seal necessary to preserve the food product stored therein during shipment, storage, and resale.

In the illustrated embodiment, container 10 includes pour opening 22, slush opening 24, strain opening 26, and straw opening 28. As shall be described further herein, pour opening 22 provides for complete emptying of the beverage from container 10, inclusive of small solids, such as ice chunks, contained therein. Slush opening 24 allows for a slush like beverage to be dispended after proper preparations. Additionally, strain opening 26 allows for only the liquid to be poured from container 10 while any solids, such as ice chunks, are strained from the beverage. Finally, straw opening 28 allow for the insertion of a straw for direct consumption of the beverage from container 10.

Alternatively, container 10 may include a spout, such as in the form of a threaded cap, pull tab, or any other beverage opening known to one of skill in the art. In an alternate embodiment, the sealed opening is an annular opening having a threaded housing located on side face 14 or 16 to allow container 10 to stack with itself and includes a threaded cap for easy opening and resealing. It shall be understood that the sealed opening(s) may also be on the top or another face of container 10 in other embodiments. In yet another alternative embodiment, the container may be a three sided container having a hermetic seal over the top or a portion of the top. Additionally, a sealed opening may function to provide venting during the microwave oven warming process to prevent pressure build up. Alternatively, container 10 may include a smaller opening or otherwise to be opened prior to warming for purposes of venting.

FIG. 1B shows an exploded view of the container 10 shown in FIG. 1A. As can be seen, top 12 of container 10 comprises cap 30 and foil 32. In the preferred form, cap 30 and bottom 13 are formed from a microwaveable plastic or similar material. Cap 30 and bottom 13 may be formed as a single unit in an alternate embodiment. Cap 30 and bottom 13 may be formed by injection molding, thermoforming, extrusion blow molding, or other plastic molding processes known to one of skill in the art. Additionally, other processes may be utilized in alternate embodiments where microwaveable materials other than plastic are utilized. In the preferred form, cap 30 is electronically welded to bottom 13. Other suitable methods for producing an airtight seal may be substituted as desired.

In the illustrated embodiment, cap 30 includes openings, such as pour opening 22, slush opening 24, strain opening 26, and straw opening 28 which each comprise a recess or plurality of recesses through cap 30. Accordingly, foil 32 includes regions for covering these corresponding openings, which may be puncturable, such as in the case of straw opening 28, or releasably adhered allowing the end user to peel back foil 32, such as in the case of strain opening 26. It shall be appreciated that the openings may be configured for use in any combination of the above recited or other opening methods.

In the illustrated embodiment, foil 32 is a pre-printed plastic foil which is microwaveable and suitable for providing a hermetic seal to the interior of container 10. In a further preferred form, foil 32 is adhered to cap 30 using a releaseable adhesive, so that a user may peel back the label to open a selected opening for dispensing the beverage in the desired fashion. Preferably, foil 32 includes tabs at each corner for allowing the user to easily peel back the appropriate section of foil 32.

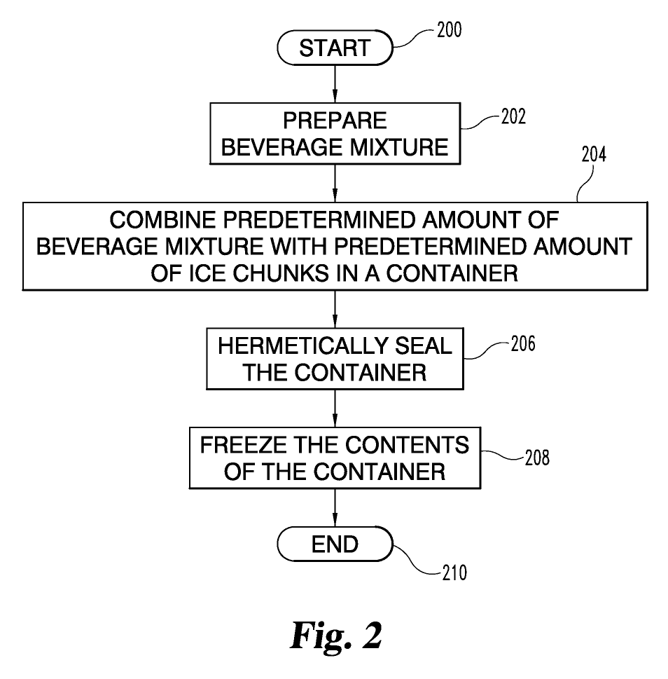

Turning to FIG. 2, a flowchart illustrating one set of steps for manufacturing a frozen beverage containing ice chunks is shown. The process begins at start point 200 with a beverage mixture being prepared (step 202). The beverage mixture is preferably prepared in a liquid form, and may be in the form of, but not limited to, a cocktail, coffee, cola, milk, or energy drink. Exemplary cocktails include, but are in no way limited to, a margarita, martini, cosmopolitan, screwdriver, daiquiri, mai tai, Manhattan, whiskey sour, rob roy, bloody mary, pina colada, white russian, tequila sunrise, sex on the beach, rusty nail, rum sour, mint julep, mojito, vodka gimlet, or kamikaze. The illustrative cocktails preferably include alcohol, or more specifically ethanol, from one or more spirits used as an ingredient.

It is essential to the present invention that the beverage mixture have a freezing point below 0° C., the freezing point of water, which allows the mixture to be returned to a liquid form while the ice chunks remain in a substantially frozen state after microwaving in a microwave oven. Preferably, the beverage mixture has a freezing point substantially below 0° C., such as −20° C. or lower. As such, beverages containing alcohol are well suited for this application. The freezing point of many spirits, such as those being 80 proof (40% alcohol (ethanol) by volume), is around −40° C. This characteristic is due to the freezing point depression caused by their ethanol content, which by itself has a freezing point of −114.3° C., well beyond any freezer in common use.

In a preferred form, the beverage mixture is cooled to a temperature below 0° C. prior to use. In a further preferred form, the beverage mixture is cooled to a temperature just above its freezing point prior to use. Once prepared, a predetermined amount of the beverage mixture is combined with a predetermined volume/quantity of ice chunks (step 204). In one form, the beverage mixture is combined with the ice chunks in a container, such as container 10 of FIG. 1. Alternatively, the mixture may be combined with the ice chunks in a temporary container, such as a reusable container, mold, or otherwise depending upon the manufacturing method chosen. Preferably, the combination is maintained at a temperature below 0° C. to prevent melting of the ice chunks.

Once mixed, the beverage mixture and ice chunks are hermetically sealed into the container (step 206). Preferably the ice chunks have a mass of greater than 10 grams in their frozen state. In the most preferred form, the ice chunks have a mass of at least 20 grams in their frozen state, such as about 30 grams. The container may be sealed through any method suitable for the container type. For example, when the container is a carton, adhesive may be applied to seal the opening of the container. As discussed previously, during the sealing process the container is preferably held at a temperature below 0° C. Finally, the sealed container is frozen to a temperature below the freezing point of the beverage mixture (stage 208). As such, the beverage mixture is frozen into a solid state which at least substantially encloses the ice chunks within the container, and the process ends at stage 210.

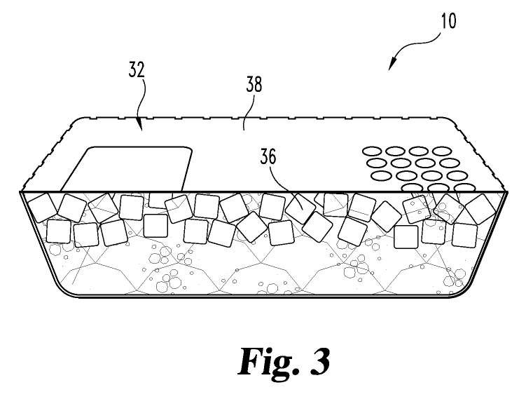

Turning to FIG. 3, a cross sectional view of the container of FIG. 1 in its frozen state, taken along the line A-A in FIG. 1 and viewed in the direction of the arrows is shown. Container 10, in its frozen state, includes a frozen solid 32 which is comprised of a frozen beverage mixture 34 which substantially encloses a plurality of ice chunks, such as ice chunk 36. Additionally, inside container 10 is a predetermined volume of head space 38. Preferably, solid 32 fills between 50% and 95% of the volume of container 10. In a further preferred form, solid 32 fills between 70% and 80% of container 10. Most preferably, solid 32 fills about 70% of container 10, allowing ample head space to allow for shaking of beverage mix 34 and ice chunks 36 during preparation by the end user.

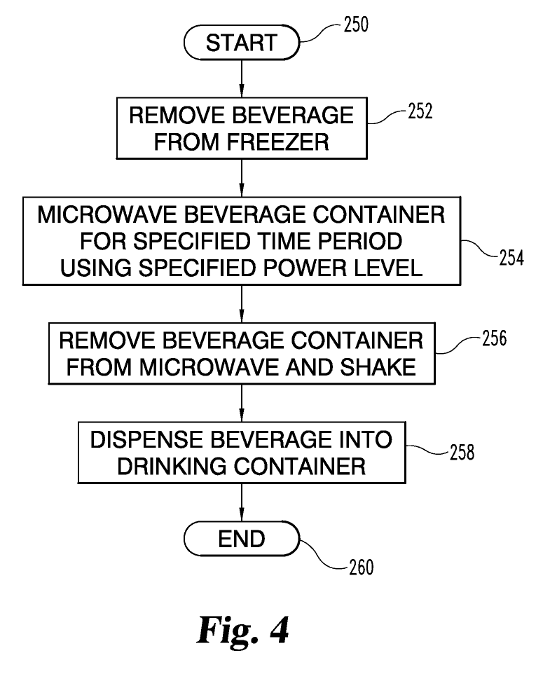

Turning to FIG. 4, a flowchart illustrating one set of steps performed by an end user in preparing a frozen beverage for consumption is illustrated. The process begins at start point 250 with a beverage container being removed from the freezer (step 252). The beverage container is then placed in a microwave oven for a specified time period and irradiated with microwaves of a specified power (step 254). In one form, the specified time and power are printed on the container. Alternatively, the specified time and power may be derived based upon the power capability of the microwave oven used by the end user. Additionally, adjustments may be made based upon a variety of factors such as the type of beverage container or the altitude of the microwave oven. Once the microwave process is complete, the end user removes the beverage container from the oven and shakes the container (stage 256). Preferably, the end user shakes the container until the beverage is chilled. The beverage may then be poured into a drinking container (stage 258). The process ends at end point 260 and the beverage is ready for consumption.

Extensive testing has been performed with numerous beverages utilizing the packaging apparatus and methods described herein. Favorable results have been found with microwave times ranging from 10-30 seconds depending upon microwave oven power, selected beverage, quantity, and other factors, such as storage temperature. In the preferred forms, the mass of each individual ice chunk was measured both during preparation and after the microwaving process, and each was found to maintain at least 90% of its original mass, with a substantial portion maintaining up to 95% of their original mass, while the surrounding beverage was substantially liquefied. In other forms, when utilizing different beverages, the ice chunks maintained at least 80% of their original mass after the microwaving process.

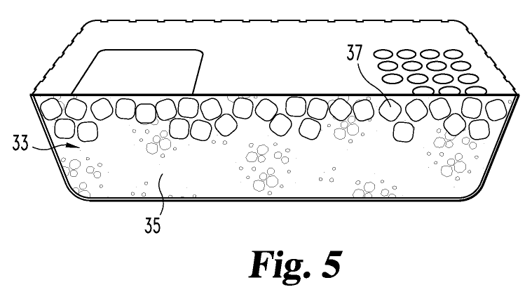

Turning to FIG. 5, a cross sectional view of the container of FIG. 1 in its prepared for consumption state, taken along the line A-A in FIG. 1 and viewed in the direction of the arrows is shown. Container 10, after undergoing the microwave warming process described in FIG. 4, includes a beverage 33 which is a mixture including a substantially liquid beverage mixture 35 and a plurality of ice chunks suspended therein, such as ice chunk 37.

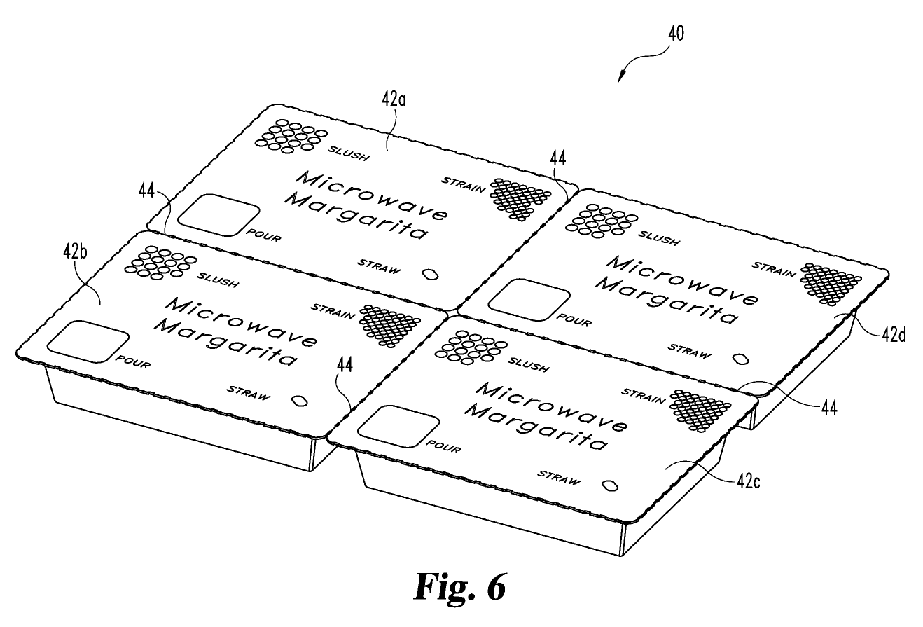

Turning to FIG. 6, a representative embodiment of a pre-packaged frozen beverage product takes the form of package 40 which comprises a plurality of containers, such as 42a, 42b, 42c, and 42d, (collectively containers 42). It shall be understood that package 40 may include more or fewer containers 42, such as, by way of non-limiting example, 2, 4, 6, or 8 containers. In order to facilitate efficient distribution, handling, and storage, containers 42 preferably are designed to be attached via connected top portions along perforated edges 44. Alternatively, containers 42 may be bound together using a variety of techniques known to one of skill in the art including, but not limited to, shrink wrapping, adhesion, and strapping. In an alternate embodiment, containers 42 may be re-packaged within a cardboard container or the like, which may also provide some form of temperature regulation and/or insulation to protect the contents of the containers from thawing during shipping, transportation, and/or storage.

While the invention has been illustrated and described in detail in the drawings and foregoing description, the same is to be considered as illustrative and not restrictive in character. Only the preferred embodiment, and certain alternative embodiments deemed useful for further illuminating the preferred embodiment, have been shown and described. All changes and modifications that come within the spirit of the invention are desired to be protected.

What is claimed:

1. A frozen beverage product capable of being partially liquefied in a microwave, comprising:
a hermetically sealed microwaveable container;
a substantially frozen solid comprising a beverage having a freezing point below 0° C. within said container; and
a plurality of ice chunks individually having a mass greater than 10 grams, wherein each of said plurality of ice chunks is at least partially enclosed within said frozen solid.

2. The frozen beverage product of claim 1, wherein said container has a length and width between 3 inches and 9 inches and a height being less than half of said length and width.

3. The frozen beverage product of claim 1, wherein said beverage is selected from the group consisting of: tea, soda, lemonade, sports drink, fruit flavored drink, and juice.

4. The frozen beverage product of claim 1, wherein said beverage has a freezing point below −5° C.

5. The frozen beverage product of claim 4, wherein said beverage comprises a mixture of at least one liquor and at least one mixer.

6. The frozen beverage product of claim 5, wherein said liquor is selected from the group consisting of: tequila, gin, rum, vodka, and whiskey.

7. The frozen beverage product of claim 6, wherein said mixer is selected from the group consisting of: fruit juice, sour mix, margarita mix, milk, and tomato juice.

8. The frozen beverage product of claim 1, wherein said container has at least one sealed opening suitable for pouring a liquid.

9. The frozen beverage product of claim 5, wherein said beverage has a freezing point below −10° C.

10. The frozen beverage product of claim 9, wherein said beverage has a freezing point below −15° C.

11. The frozen beverage product of claim 10, wherein said beverage has a freezing point below −20° C.

12. The frozen beverage product of claim 2, wherein said frozen solid and said plurality of ice chunks occupy more than 70% and less than 80% of said container.

13. The frozen beverage product of claim 12, wherein said frozen solid and said plurality of ice chunks occupy approximately 75% of said container.

14. The frozen beverage product of claim 12, wherein the volume of said plurality of ice chunks is between 25% and 50% of the volume of said frozen solid.

15. The frozen beverage product of claim 1, wherein said container comprises at least two sealed openings.

16. The frozen beverage product of claim 15, wherein at least one of said sealed openings comprises a puncturable seal.

17. The frozen beverage product of claim 15, wherein at least one of said sealed openings comprises a releasable seal which may be peeled back from said container in order to allow said beverage to be poured from said container.

18. The frozen beverage product of claim 15, wherein at least one of said sealed openings comprises a plurality of smaller openings for straining said beverage.

19. The frozen beverage product of claim 15, wherein said container comprises at least four sealed openings.

20. The frozen beverage product of claim 1 wherein each of said plurality of ice chunks individually has a mass greater than 20 grams.

21. A method for making a microwaveable frozen beverage comprising:
preparing a beverage having a freezing point below 0° C.;
combining a predetermined volume of said beverage with a plurality of ice chunks to create a first suspension, wherein each of said plurality of ice chunks has a mass greater than 10 grams;
freezing said first suspension to form a frozen solid, wherein said beverage forms a solid which at least partially encloses said plurality of ice chunks; and
hermetically sealing said frozen solid within a microwaveable container.

22. The method of claim 21, wherein said combining, freezing, and sealing steps are performed at or below 0° C.

23. The method of claim 22 wherein said predetermined volume is within the range of 4-96 ounces.

24. The method of claim 23, wherein said predetermined volume is within the range of about 6-32 ounces.

25. The method of claim 24, wherein said predetermined volume is within the range of about 8-16 ounces.

26. The method of claim 21, wherein said beverage has a freezing point below −10° C.

27. The method of claim 26, wherein said beverage includes at least one liquor.

28. The method of claim 27, wherein said beverage has a freezing point below −15° C.

29. A method for preparing a beverage from a pre-packaged container comprising:
storing a hermetically sealed microwaveable container comprising a frozen suspension of a mixture of liquor and at least one mixer and a plurality of ice chunks at a temperature at or below the freezing point of said mixture; and
microwaving said container for a predetermined period of time using a selected power level to substantially melt said mixture while maintaining said plurality of ice chunks in a substantially frozen state.

30. The method of claim 29, further comprising the steps of:
shaking said container to lower the temperature of said mixture; and
pouring said mixture from said container into a beverage container for consumption.

31. The method of claim 30, wherein said plurality of ice chunks have a mass of at least 20 grams prior to said microwaving step.

32. The method of claim 31, wherein a substantial portion of said plurality of ice chunks have a mass after said microwaving step that is greater than 80% of its mass prior to said microwaving step.

33. The method of claim 32, wherein each of said plurality of ice chunks has a mass after said microwaving step that is greater than 90% of its mass prior to said microwaving step.

34. The method of claim 32, wherein a substantial portion of said plurality of ice chunks have a mass after said microwaving step that is greater than 95% of its mass prior to said microwaving step.

35. The method of claim 30, wherein said predetermined period of time and said selected power level are printed on said container.
